(19) United States
(12) Patent Application Publication
(10) Pub. No.: US 2014/0027116 A1
(43) Pub. Date: Jan. 30, 2014

(54) POLYMER NANOCOMPOSITE, PROCESS FOR MAKING AND USE OF SAME

(71) Applicants: Radhika Suresh, Sugar Land, TX (US); Michael Johnson, Katy, TX (US); Soma Chakraborty, Houston, TX (US); Donald Horner, Spring, TX (US)

(72) Inventors: Radhika Suresh, Sugar Land, TX (US); Michael Johnson, Katy, TX (US); Soma Chakraborty, Houston, TX (US); Donald Horner, Spring, TX (US)

(73) Assignee: BAKER HUGHES INCORPORATED, Houston, TX (US)

(21) Appl. No.: 13/561,314

(22) Filed: Jul. 30, 2012

(51) Int. Cl. C09K 8/56; E21B 33/13

(52) U.S. Cl. CPC C09K 8/56; E21B 33/13
USPC 166/292; 507/219

(57) ABSTRACT

A process for stabilizing particles includes disposing reactive nanoparticles in a borehole; contacting the reactive nanoparticles with a resin; introducing a curing agent; and curing the resin and reactive nanoparticles with the curing agent to form a nanocomposite, wherein, during curing, the nanocomposite is bonded to the particles to stabilize the particles. A process for consolidating particles includes coating the particles with a resin; introducing reactive nanoparticles; curing the resin and reactive nanoparticles with a curing agent to form a nanocomposite which is bonded to the particles; and controlling a rate of the curing by an amount of the curing agent which is present with the resin, wherein the nanocomposite bonded to the particles is thermally stable up to at least 600° F. (315° C.). A system comprises a resin; reactive nanoparticles; a curing agent to form a nanocomposite; and particles disposed in a downhole location to which the nanocomposite binds.

### BACKGROUND

Loose particulates in sub-surface locations interfere with oil field processes. During drilling, some material mobilized by a drill bit can be removed from a borehole by transmission to the surface. Residual particles can accumulate near the bottom of the borehole as well as becoming temporarily lodged in an open hole wall. Under a perforation or fracking operation, more particulates can be formed or released, with some being flushed to the surface. Particulates that remain or are produced later in the borehole or surrounding formation can damage equipment. Remedial measures to stabilize the borehole include immobilization of the particulates or creation of physical barriers to their movement using such devices such as a gravel pack or and sand screen. In some situations, a polymer can be used to encase particulates in so-called sand consolidation. However, the lifetime of the polymer in sand consolidation systems can be limited due to extreme conditions downhole.

To improve properties of such polymers, bulk materials are sometimes added to a polymer matrix. Some of these bulk materials also diminish performance characteristics or introduce unfavorable properties, for example, premature degradation of the polymer. Balancing the need for more robust polymer compositions with available bulk materials has proved challenging. Thus, new materials and methods to improve polymer materials would be well received in the art.

### BRIEF DESCRIPTION

The above and other deficiencies of the prior art are overcome by, in an embodiment, a process for stabilizing particles, the process comprising: disposing reactive nanoparticles in an environment which the particles; contacting the reactive nanoparticles with a resin; introducing a curing agent; and curing the resin and reactive nanoparticles with the curing agent to form a nanocomposite, wherein, during curing, the nanocomposite is bonded to the particles to stabilize the particles.

In another embodiment, a process for consolidating particles comprises: coating the particles with a resin; introducing reactive nanoparticles; curing the resin and reactive nanoparticles with a curing agent to form a nanocomposite which is bonded to the particles; and controlling a rate of the curing by an amount of the curing agent which is present with the resin, wherein the nanocomposite bonded to the particles is thermally stable up to at least 600° F. (315° C.).

In a further embodiment, a particle stabilizing system comprises: a resin; reactive nanoparticles; a curing agent to cure the resin and reactive nanoparticles to form a nanocomposite; and particles disposed in a downhole location to which the nanocomposite binds.

### BRIEF DESCRIPTION OF THE DRAWINGS

The following descriptions should not be considered limiting in any way. With reference to the accompanying drawings, like elements are numbered alike:

FIG. 1 shows a graph of storage modulus versus temperature for various compositions; and

FIG. 2 shows another graph of storage modulus versus temperature for various compositions.

### DETAILED DESCRIPTION

A detailed description of one or more embodiments is presented herein by way of exemplification and not limitation.

It has been found that a nanocomposite having a reaction product of resin, reactive nanoparticles, and curing agent exhibits an increased glass transition temperature as compared to the native resin or the resin crosslinked by a curing agent without reactive nanoparticles. The reactive nanoparticles are compatible with and react with the resin such that the reactive nanoparticles easily disperse in and combine with the resin. In addition, a synergistic effect of a certain relative amount of the reactive nanoparticles, curing agent, and resin enhances performance and properties of the nanocomposite such as storage modulus. Moreover, the nanocomposite is capable of bonding to mobile or stationary particles or substrates to produce a consolidation of such particles or substrates that has high compressive strength and exhibits excellent thermal stability without loss of permeability in applications requiring flow through the consolidated material.

In an embodiment, a nanocomposite is prepared by combining a resin and reactive nanoparticles, e.g., a silsesquioxane, graphene, and the like. A curing agent is introduced to the resin and reactive nanoparticles to form a composition, and a reaction product of the composition is formed to prepare the nanocomposite. A total amount of the reactive nanoparticles and curing agent in the composition can be from 1 weight percent (wt %) to 70 wt %, based on a weight of the composition.

The nanocomposite is useful in the stabilization of particles. That is, mobile or loose particles can be consolidated to become immobile by application of the composition to the particles with subsequent curing of the composition to bond the nanocomposite to the particles. In an embodiment, a process for stabilizing particles includes disposing reactive nanoparticles in an environment, e.g., a borehole or formation, containing particles. A resin contacts the reactive nanoparticles, and a curing agent is introduced. The resin and reactive nanoparticles are cured with the curing agent to form the nanocomposite, and, during curing, the nanocomposite is bonded to the particles to stabilize the particles. In an embodiment, the particles are coated with a component of the nanocomposite. Thus, the particles are immobilized and consolidated upon curing of the resin and reactive nanoparticles with the curing agent.

In an embodiment, the reactive nanoparticles comprise silsesquioxane, graphene, graphene fiber, nanographite, oxides thereof, or a combination comprising at least one of the foregoing. In a particular embodiment, the reactive nanoparticles are a silsesquioxane. Silsesquioxanes, also referred to as polysilsesquioxanes, polyorganosilsesquioxanes, or polyhedral oligomeric silsesquioxanes (POSS), are polyorganosilicon oxide compounds of general formula RSiO_{1.5} (where R is a hydrogen, inorganic group, or organic group) having defined closed or open cage structures (closo or nido structures, which are called respectively completely condensed or incompletely structures). Silsesquioxanes can be prepared by acid and/or base-catalyzed condensation of functionalized silicon-containing monomers such as tetraalkoxysilanes including tetramethoxysilane and tetraethoxysilane, alkyltrialkoxysilanes such as methyltrimethoxysilane and methyltrimethoxysilane, as well as other groups.

The silsesquioxane has a closed cage structure, an open cage structure, or a combination comprising at least one of the foregoing. The silsesquioxane can have any shape of cage structure such as cubes, hexagonal prisms, octagonal prisms, decagonal prisms, dodecagonal prisms, and the like. Additionally, the cage structure of the silsesquioxane comprises from 4 to 30 silicon atoms, specifically, 4 to 20 silicon atoms, and more specifically 4 to 16 silicon atoms, with each silicon atom in the cage structure being bonded to oxygen. It should be noted that the term “cage structure” is meant to include the SiO_{1.5} portion of the general silsesquioxane formula RSiO_{1.5}, and not the R-group.

Nanographite is a cluster of plate-like sheets of graphite, in which a stacked structure of one or more layers of graphite, which has a plate-like two dimensional structure of fused hexagonal rings with an extended delocalized π-electron system, are layered and weakly bonded to one another through π-π stacking interaction. Nanographite has both micro- and nano-scale dimensions, such as for example an average particle size of 1 to 20 μm, specifically 1 to 15 μm, and an average thickness (smallest) dimension in nano-scale dimensions, and an average thickness of less than 1 μm, specifically less than or equal to 700 nm, and still more specifically less than or equal to 500 nm.

In an embodiment, the reactive nanoparticle is a graphene including nanographene and graphene fibers (i.e., graphene particles having an average largest dimension of greater than 1 mm and an aspect ratio of greater than 10, where the graphene particles form an interbonded chain). Graphene and nanographene, as disclosed herein, are effectively two-dimensional particles of nominal thickness, having of one or more layers of fused hexagonal rings with an extended delocalized π-electron system, layered and weakly bonded to one another through π-π stacking interaction. Graphene in general, including nanographene, can be a single sheet or a stack of several sheets having both micro- and nano-scale dimensions, such as in some embodiments an average particle size of 1 to 20 μm, specifically 1 to 15 μm, and an average thickness (smallest) dimension in nano-scale dimensions of less than or equal to 50 nm, specifically less than or equal to 25 nm, and more specifically less than or equal to 10 nm. An exemplary nanographene can have an average particle size of 1 to 5 μm, and specifically 2 to 4 μm. In addition, smaller nanoparticles or sub-micron sized particles as defined above may be combined with nanoparticles having an average particle size of greater than or equal to 1 μm. In a specific embodiment, the reactive nanoparticle is graphene.

Graphene can be prepared by exfoliation of graphite or by a synthetic procedure by “unzipping” a nanotube to form a nanographene ribbon, followed by derivatization of the nanographene to prepare, for example, nanographene oxide.

Exfoliation to form graphene or nanographene can be carried out by exfoliation of a graphite source such as graphite, intercalated graphite, and nanographite. Exemplary exfoliation methods include, but are not limited to, fluorination, acid intercalation, acid intercalation followed by thermal shock treatment, and the like, or a combination comprising at least one of the foregoing. Exfoliation of the nanographite provides a nanographene having fewer layers than non-exfoliated nanographite. It will be appreciated that exfoliation of nanographite can provide the nanographene as a single sheet only one molecule thick, or as a layered stack of relatively few sheets. In an embodiment, exfoliated nanographene has fewer than 50 single sheet layers, specifically fewer than 20 single sheet layers, specifically fewer than 10 single sheet layers, and more specifically fewer than 5 single sheet layers.

The reactive nanoparticles are generally particles having an average particle size, in at least one dimension, of less than one micrometer (μm). As used herein “average particle size” refers to the number average particle size based on the largest linear dimension of the reactive particle (sometimes referred to as “diameter”). Particle size, including average, maximum, and minimum particle sizes, may be determined by an appropriate method of sizing particles such as, for example, static or dynamic light scattering (SLS or DLS) using a laser light source. Reactive nanoparticles may include both particles having an average particle size of 250 nm or less, and particles having an average particle size of greater than 250 nm to less than 1 μm (sometimes referred in the art as “sub-micron sized” particles). In an embodiment, a reactive nanoparticle can have an average particle size of about 0.1 nanometers (nm) to about 500 nm, specifically 0.5 nm to 250 nm, more specifically about 1 nm to about 150 nm, more specifically about 1 nm to about 125 nm, and still more specifically about 1 nm to about 75 nm. The reactive nanoparticles can be monodisperse, where all particles are of the same size with little variation, or polydisperse, where the particles have a range of sizes and are averaged. Generally, polydisperse reactive nanoparticles are used. Reactive nanoparticles of different average particle size can be used, and in this way, the particle size distribution of the reactive nanoparticles can be unimodal (exhibiting a single size distribution), bimodal exhibiting two size distributions, or multi-modal, exhibiting more than one particle size distribution.

The minimum particle size for the smallest 5 percent of the reactive nanoparticles can be less than 2 nm, specifically less than or equal to 1 nm, and more specifically less than or equal to 0.5 nm. Similarly, the maximum particle size for 95% of the reactive nanoparticles can be greater than or equal to 900 nm, specifically greater than or equal to 750 nm, and more specifically greater than or equal to 500 nm. The reactive nanoparticles can have a high surface area of greater than 300 m²/g, and in a specific embodiment, 300 m²/g to 1800 m²/g, specifically 500 m²/g to 1500 m²/g. In a particular embodiment, the reactive nanoparticle has a size from 0.5 nm to 10 nm.

In an embodiment, the reactive nanoparticle can be derivatized to include functional groups such as, for example, epoxy, ether, ketone, alkaryl, lactone, alkyl, alkoxy, haloakyl, cycloalkyl, heterocycloalkyl, cycloalkyloxy, aryl, aralkyl, aryloxy, aralkyloxy, heteroaryl, heteroaralkyl, alkenyl, alkynyl, amine, alkyleneamine, aryleneamine, alkenyleneamine, hydroxy, carboxy (e.g., a carboxylic acid group or salt), halogen, hydrogen, or a combination comprising at least one of the forgoing functional groups. The reactive nanoparticles can be derivatized to introduce chemical functionality to the reactive nanoparticle. For example, for nanographene, the surface and/or edges of the nanographene sheet is derivatized to increase dispersibility in and interaction with a resin matrix. In an embodiment, the derivatized reactive nanoparticles can be hydrophilic, hydrophobic, oxophilic, lipophilic, or may possess a combination of these properties to provide a balance of desirable net properties, by use of different functional groups.

The reactive nanoparticles can be derivatized by, for example, amination to include amine groups, where amination may be accomplished by nitration followed by reduction, or by nucleophilic substitution of a leaving group by an amine, substituted amine, or protected amine, followed by deprotection as necessary. In another embodiment, a reactive nanoparticle, e.g., nanographene, can be derivatized by oxidative methods to produce an epoxy, hydroxy group or glycol group using a peroxide, or as applicable by cleavage of a double bond by for example a metal mediated oxidation such as a permanganate oxidation to form ketone, aldehyde, or carboxylic acid functional groups.

Where the functional groups are alkyl, aryl, aralkyl, alkaryl, or a combination of these groups, the functional groups can be attached directly to the derivatized reactive nanoparticle by a carbon-carbon bond (or carbon-silicon bond for silsesquioxanes) without intervening heteroatoms, to provide greater thermal and/or chemical stability, to the derivatized reactive nanoparticles, as well as a more efficient synthetic process requiring fewer steps; by a carbon-oxygen (or silicon-oxygen for silsesquioxanes) bond (where the reactive nanoparticles contain an oxygen-containing functional group such as hydroxy or carboxylic acid); or by a carbon-nitrogen (or silicon-nitrogen for silsesquioxanes) bond (where the reactive nanoparticles contain a nitrogen-containing functional group such as amine or amide). In an embodiment, the reactive nanoparticles can be derivatized by metal mediated reaction with a C₆₋₃₀ aryl or C₇₋₃₀ aralkyl halide (F, Cl, Br, I) in a carbon-carbon (or silicon-carbon) bond forming step, such as by a palladium-mediated reaction such as the Stille reaction, Suzuki coupling, or diazo coupling, or by an organocopper coupling reaction. In another embodiment, a reactive nanoparticle, such as a graphene, can be directly metallated by reaction with, e.g., an alkali metal such as lithium, sodium, or potassium, followed by reaction with a C₁₋₃₀ alkyl or C₇₋₃₀ alkaryl compound with a leaving group such as a halide (Cl, Br, I) or other leaving group (e.g., tosylate, mesylate, etc.) in a carbon-carbon bond forming step. The aryl or aralkyl halide, or the alkyl or alkaryl compound, can be substituted with a functional group such as hydroxy, carboxy, ether, or the like. Exemplary groups include, for example, hydroxy groups, carboxylic acid groups, alkyl groups such as methyl, ethyl, propyl, butyl, pentyl, hexyl, octyl, dodecyl, octadecyl, and the like; aryl groups including phenyl and hydroxyphenyl; aralkyl groups such as benzyl groups attached via the aryl portion, such as in a 4-methylphenyl, 4-hydroxymethylphenyl, or 4-(2-hydroxyethyl)phenyl (also referred to as a phenethylalcohol) group, or the like, or aralkyl groups attached at the benzylic (alkyl) position such as found in a phenylmethyl or 4-hydroxyphenyl methyl group, at the 2-position in a phenethyl or 4-hydroxyphenethyl group, or the like. In an exemplary embodiment, the derivatized reactive nanoparticles are graphene substituted with a benzyl, 4-hydroxybenzyl, phenethyl, 4-hydroxyphenethyl, 4-hydroxymethylphenyl, 4-(2-hydroxyethyl)phenyl group, or a combination comprising at least one of the foregoing groups. In some embodiments, the reactive nanoparticles is an oxide of graphene or nanographite.

According to an embodiment, the reactive nanoparticle is a silsesquioxane that comprises a functional group bonded to a silicone atom of the silsesquioxane. In a specific embodiment, the functional group bonded to the silicon atom comprises an alkyl, alkoxy, haloakyl, cycloalkyl, heterocycloalkyl, cycloalkyloxy, aryl, aralkyl, aryloxy, aralkyloxy, heteroaryl, heteroaralkyl, alkenyl, alkynyl, amine, alkyleneamine, aryleneamine, alkenyleneamine, hydroxy, carboxyl, ether, epoxy, ketone, halogen, hydrogen, or combination comprising at least one of the foregoing. Thus, the silsesquioxane derivatized with a functional group includes a group such as an alcohol, amine, carboxylic acid, epoxy, ether, fluoroalkyl, halide, imide, ketone, methacrylate, acrylate, silica, nitrile, norbornenyl, olefin, polyethylene glycol (PEG), silane, silanol, sulfonate, thiol, and the like. Furthermore, the silsesquioxane can have from one functional group to as many functional groups as there are silicon atoms in the cage structure of the silsesquioxane. In a specific embodiment, the silsesquioxane is a derivatized octasilsesquioxane R₈₋ₙHₙ(SiO_{1.5})₈ (where 0≦n≦8, and R can be a same or different functional group), and the number of functional groups varies with the number of silicon atoms in the cage structure, i.e., from 0 to 8 functional groups.

Exemplary silsesquioxanes having a closed cage structure include 1-allyl-3,5,7,9,11,13,15-heptacyclopentylpentacyclo[9.5.1.1(3,9).1(5,15).1(7,13)]octasiloxane; 1-allyl-3,5,7,9,11,13,15-heptaisobutylpentacyclo[9.5.1.1(3,9).1(5,15).1(7,13)]octasiloxane; 1-[3-(2-aminoethyl)amino]propyl-3,5,7,9,11,13,15-isobutylpentacyclo[9.5.1.1(3,9).1(5,15).1(7,13)]octasiloxane; 1-chlorobenzylethyl-3,5,7,9,11,13,15-heptaisobutylpentacyclo[9.5.1.1(3,9).1(5,15).1(7,13)]octasiloxane; 1-(4-chlorobenzyl)-3,5,7,9,11,13,15-heptacyclopentylpentacyclo[9.5.1.1(3,9).1(5,15).1(7,13)]octasiloxane; 1-chloropropyl-3,5,7,9,11,13,15-isobutylpentacyclo[9.5.1.1(3,9).1(5,15).1(7,13)]octasiloxane; (cyanopropyldimethylsilyloxy)heptacyclopentylpentacyclooctasiloxane; 1-(2-trans-cyclohexanediol)ethyl-3,5,7,9,11,13,15-isobutylpentacyclo[9.5.1.1(3,9).1(5,15).1(7,13)]octasiloxane; 1-(3-cyclohexen-1-yl)-3,5,7,9,11,13,15-heptacyclopentylpentacyclo[9.5.1.1(3,9).1(5,15).1(7,13)]octasiloxane; dodecaphenyl-dodecasiloxane; 1-[2-(3,4-epoxycyclohexyl)ethyl]-3,5,7,9,11,13,15-isobutylpentacyclo[9.5.1.1(3,9).1(5,15).1(7,13)]octasiloxane; 1,3,5,7,9,11,13-heptacyclopentyl-15-glycidylpentacyclo[9.5.1.1(3,9).1(5,15).1(7,13)]octasiloxane; 1-(3-glycidyl)propoxy-3,5,7,9,11,13,15-isobutylpentacyclo[9.5.1.1(3,9).1(5,15).1(7,13)]octasiloxane; octakis(tetramethylammonium)pentacyclo[9.5.1.1(3,9).1(5,15).1(7,13)]octasiloxane-1,3,5,7,9,11,13,15-octakis(yloxide) hydrate; 3-hydroxypropylheptaisobutyl-octasiloxane; 1-(3-mercapto)propyl-3,5,7,9,11,13,15-isobutylpentacyclo[9.5.1.1(3,9).1(5,15).1(7,13)]octasiloxane; octacyclohexenylethyldimethylsilyloxy-octasiloxane; 1,3,5,7,9,11,13,15-octacyclohexylpentacyclooctasiloxane; octa[(1,2-epoxy-4-ethylcyclohexyl)dimethylsiloxy]octasiloxane; octa[(3-glycidyloxypropyl)dimethylsiloxy]octasiloxane; octa[(3-hydroxypropyl)dimethylsiloxy]octasiloxane; 1,3,5,7,9,11,13,15-octakis[2-(chlorodimethylsilyl)ethyl]pentacyclo[9.5.1.1(3,9).1(5,15).1(7,13)]octasiloxane; 1,3,5,7,9,11,13,15-octakis(dimethylsilyloxy)pentacyclo[9.5.1.1(3,9).1(5,15).1(7,13)]octasiloxane; 1,3,5,7,9,11,13,15-octamethylpentacyclo[9.5.1.1(3,9).1(5,15).1(7,13)]octasiloxane; 1,3,5,7,9,11,13,15-octaphenylpentacyclo[9.5.1.1(3,9).1(5,15).1(7,13)]octasiloxane; 1,3,5,7,9,11,13,15-octa(2-trichlorosilyl)ethyl)pentacyclo[9.5.1.1(3,9).1(5,15).1(7,13)]octasiloxane; 1,3,5,7,9,11,13,15-octavinylpentacyclo[9.5.1.1(3,9).1(5,15).1(7,13)]octasiloxane; 1-(2,3-propanediol)propoxy-3,5,7,9,11,13,15-isobutylpentacyclo-[9.5.1.1(3,9).1(5,15).1(7,13)]octasiloxane; 3-(3,5,7,9,11,13,15-heptaisobutylpentacyclo[9.5.1.1(3,9).1(5,15).1(7,13)]octasiloxan-1-yl)propylmethacrylate; (3-tosyloxypropyl)-heptaisobutyloctasiloxane; 1-(trivinylsilyloxy)-3,5,7,9,11,13,15-heptacyclopentylpentacyclo[9.5.1.1(3,9).1(5,15).1(7,13)]octasiloxane; 1-vinyl-3,5,7,9,11,13,15-isobutylpentacyclo[9.5.1.1(3,9).1(5,15).1(7,13)]octasiloxane, (3-(2,2-bis(hydroxymethyl)butoxy)propyl)dimethylsiloxy-3,5,7,9,11,13,15-isobutylpentacyclo[9.5.1.1.(3,9).1(5,15).1(7,13)]octasiloxane; octa(3-hydroxy-3-methylbutyldimethylsiloxy)octasiloxane; 1-(3-amino)propyl-3,5,7,9,11,13,15-isobutylpentacyclo[9.5.1.1.(3,9).1(5,15).1(7,13)]octasiloxane; 1-(3-amino)propyl-3,5,7,9,11,13,15-isooctylpentacyclo[9.5.1.1.(3,9).1(5,15).1(7,13)]octasiloxane; 1,3,5,7,9,11,13,15-octaminophenylpentacyclo[9.5.1(3,9).1(5,15).1(7,13)]octasiloxane; octa-n-phenylaminopropyl)-octasiloxane; n-methylaminopropyl-heptaisobutyl-octasiloxane; octaethylammoniumoctasiloxane chloride; 1-(4-amino)phenyl-3,5,7,9,11,13,15-cyclohexlpentacyclo[9.5.1.1(3,9).1(5,15).1(7,13)]octasiloxane; 1-(amino)phenyl-3,5,7,9,11,13,15-cyclohexlpentacyclo[9.5.1.1(3,9).1(5,15).1(7,13)]octasiloxane; 1-(4-amino)phenyl-3,5,7,9,11,13,15-heptaisobutylpentacyclo[9.5.1.1(3,9).1(5,15).1(7,13)]octasiloxane; 1-(amino)phenyl-3,5,7,9,11,13,15-heptaisobutylpentacylco[9.5.1.1(3,9).1(5,15).1(7,13)]octasiloxane; 1-[(3-maleamic acid)propyl]-3,5,7,9,11,13,15-heptacyclohexylpentacyclo[9.5.1.1(3,9).1(5,15).1(7,13)]-octasiloxane; 1-[(3-maleamic acid)propyl]-3,5,7,9,11,13,15-heptaisobutylpentacyclo[9.5.1.1(3,9).1(5,15).1(7,13)]-octasiloxane; octamaleamic acid octasiloxane; trimethoxy-[2-(7-oxabicyclo[4.1.0]hept-3-yl)ethyl]silane, hydrolyzed; 2-[[3-(trimethoxysilyl)propoxy]methyl]-oxirane, hydrolyzed; ethyl 3,5,7,9,11,13,15-heptaethylpentacyclo[9.5.1.1(3,9).1(5,15).1(7,13)]octasiloxane-1-undecanoate; 1-(3-glycidyl)propoxy-3,5,7,9,11,13,15-isooctylpentacyclo[9.5.1.1(3,9).1(5,15).1(7,13)]octasiloxane; 3,7,14-tris{[3-(epoxypropoxy)propyl]dimethylsilyloxy}-1,3,5,7,9,11,14-heptacyclohexyltricyclo[7.3.3.1(5,11)]heptasiloxane; 3,7,14-tris {[3-(epoxypropoxy)propyl]dimethylsilyloxy}-1,3,5,7,9,11,14-heptaisobutyltricyclo[7.3.3.1(5,11)]heptasiloxane; octatrifluoropropyloctasiloxane; endo-3,7,14-trifluoropropyl-1,3,5,7,9,11,14-heptaisobutyltricyclo[7.3.3.1(5,11)]heptasiloxane; 1-chlorobenzyl-3,5,7,9,11,13,15-heptaisobutylpentacyclo[9.5.1.1(3,9).1(5,15).1(7,13)]octasiloxane; 1,3,5,7,9,11,13,15-octakis(1,2-dibromoethyl)-pentacyclo[9.5.1.1(3,9).1(5,15).1(7,13)]octasiloxane; 1-[(3-maleimide)propyl]-3,5,7,9,11,13,15-heptacyclohexylpentacyclo[9.5.1.1(3,9).1(5,15).1(7,13)]-octasiloxane; 1-[(3-maleimide)propyl]-3,5,7,9,11,13,15-heptaisobutylpentacyclo[9.5.1.1(3,9).1(5,15).1(7,13)]-octasiloxane; 3-(3,5,7,9,11,13,15-heptaisobutylpentacyclo[9.5.1.1(3,9).1(5,15).1(7,13)]octasiloxan-1-yl)propylacrylate; 3-[3,5,7,9,11,13,15-heptacyclohexylpentacyclo[9.5.1.1(3,9).1(5,15).1(7,13)]octasiloxan-1-yl]methylmethacrylate; 3-[3,5,7,9,11,13,15-heptaisobutylpentacyclo[9.5.1.1(3,9).1(5,15).1(7,13)]octasiloxan-1-yl]methylmethacrylate; 3-[3,5,7,9,11,13,15-heptaethylpentacyclo[9.5.1.1(3,9).1(5,15).1(7,13)]octasiloxan-1-yl]methylmethacrylate; 3-[3,5,7,9,11,13,15-heptaethylpentacyclo[9.5.1.1(3,9).1(5,15).1(7,13)]octasiloxan-1-yl]propylmethacrylate; 3-[3,5,7,9,11,13,15-heptaisooctylpentacyclo[9.5.1.1(3,9).1(5,15).1(7,13)]octasiloxanlyl]methylmethacrylate; 3-(3,5,7,9,11,13,15-heptaisooctylpentacyclo[9.5.1.1(3,9).1(5,15).1(7,13)]octasiloxan-1-yl)propylmethacrylate; 3-(3,5,7,9,11,13,15-heptaphenylpentacyclo[9.5.1.1(3,9).1(5,15).1(7,13)]octasiloxan-1-yl)propylmethacrylate; octasiloxa-octapropylmethacrylate; octasiloxa-octapropylacrylate; dodecaphenyldecasiloxane; octaisooctyloctasiloxane; phenylheptaisobutyloctasiloxane; phenylheptaisooctyloctasiloxane; isooctylhetpaphenyloctasiloxane; octaisobutyloctasiloxane; octamethyloctasiloxane; octaphenyloctasiloxane; octakis(tetramethylammonium)pentacyclo[9.5.1.1(3,9).1(5,15).1(7,13)]octasiloxane 1,3,5,7,9,11,13,15-octakis(cyloxide)hydrate; octakis(trimethylsiloxy)pentacyclo[9.5.1.1(3,9).1(5,15).1(7,13)]octasiloxane; 3,5,7,9,11,13,15-heptaisobutylpentacyclo[9.5.1.1(3,9).1(5,15).1(7,13)]octasiloxane-1-butyronitrile; 1-[2-(5-norbornen-2-yl)ethyl]-3,5,7,9,11,13,15-heptaethylpentacyclo[9.5.1.1(3,9).1(7,13)]octasiloxane; 1-[2-(5-norbornen-2-yl)ethyl]-3,5,7,9,11,13,15-heptaisobutylpentacyclo[9.5.1.1(3,9).1(7,13)]octasiloxane; 1-allyl-3,5,7,9,11,13,15-heptaisobutylpentacyclo[9.5.1.1(3,9).1(7,13)]octasiloxane; 1,3,5,7,9,11,13-heptaisobutyl-15-vinylpentacyclo[9.5.1.1(3,9).1(5,15).1(7,13)]octasiloxane; 1,3,5,7,9,11,13,15-octa[2-(3-cyclohexenyl)ethyldimethylsiloxy]pentacyclo[9.5.1.1(3,9).1(5,15).1(7,13)]octasiloxane; 1,3,5,7,9,11,13,15-octavinylpentacyclo[9.5.1.1(3,9).1(5,15).1(7,13)]octasiloxane; 1,3,5,7,9,11,13,15-octa[vinyldimethylsiloxy]pentacyclo[9.5.1.1(3,9).1(5,15).1(7,13)]octasiloxane; 1,3,5,7,9,11,13,15-octakis(dimethylsilyloxy)pentacyclo[9.5.1.1(3,9).1(5,15).1(7,13)]octasiloxane; 1,3,5,7,9,11,13,15-octahydropentacyclo[9.5.1.1(3,9).1(5,15).1(7,13)]octasiloxane; 1-(3-mercapto)propyl-3,5,7,9,11,13,15-isobutylpentacyclo[9.5.1.1(3,9).1(5,15).1(7,13)]octasiloxane; 1-(3-mercapto)propyl-3,5,7,9,11,13,15-isooctylpentacyclo[9.5.1.1(3,9).1(5,15).1(7,13)]octasiloxane; and the like.

Exemplary silsesquioxanes having an open cage structure include 1,3,5,7,9,11,14-heptacyclohexyltricyclo[7.3.3.1(5,11)]heptasiloxane-endo-3,7,14-triol; 1,3,5,7,9,11,14-heptacyclopentyltricyclo[7.3.3.1(5,11)]heptasiloxane-endo-3,7,14-triol; 1,3,5,7,9,11-octaisobutyltetracyclo[7.3.3.1(5,11)]octasiloxane-endo-3,7-diol; 1,3,5,7,9,11,14-heptaethyltricyclo[7.3.3.1(5,11)]heptasiloxane-endo-3,7,14-triol; 1,3,5,7,9,11,14-heptaisobutyltricyclo[7.3.3.1(5,11)]heptasiloxane-endo-3,7,14-triol; 1,3,5,7,9,11,14-heptaisooctyltricyclo[7.3.3.1(5,110]heptasiloxane-endo-3,7,14-triol; 1,3,5,7,9,11,14-heptaphenyltricyclo[7.3.3.1(5,11)]heptasiloxane-endo-3,7,14-triol; tricyclo[7.3.3.3(3,7)]octasiloxane-5,11,14,17-tetraol-1,3,5,7,9,11,14,17-octaphenyl; 9-{dimethyl[2-(5-norbornen-2-yl)ethyl]silyloxy}-1,3,5,7,9,11,14-heptaisobutyltricyclo[7.3.3.1 5,11]heptasiloxane-1,5-diol; endo-3,7,14-tris{dimethyl[2-(5-norbornen-2-yl)ethyl]silyloxy}-1,3,5,7,9,11,14-heptaisobutyltricyclo[7.3.3.1(5,11)]heptasiloxane; [[dimethyl(trifluoromethyl)ethyl]silyloxy]heptacyclopentyltricycloheptasiloxanediol; 1,3,5,7,9,11,14-heptacyclohexyltricyclo[7.3.3.1(5,11)]heptasiloxane-3,7,14-triol; 1,3,5,7,9,11,14-heptaisobutyltricyclo[7.3.3.1(5,11)]heptasiloxane-endo-3,7,14-triol; 1,3,5,7,9,11-octacyclopentyltetracyclo[7.3.3.1(5,11)]octasiloxane-endo-3,7-diol; 1,3,5,7,9,11,14-hepta-isooctyltricyclo[7.3.3.1(5,11)]heptasiloxane-endo-3,7,14-triol; endo-3,7,14-trifluoro-1,3,5,7,9,11,14-heptacyclopentyltricyclo[7.3.3.1(5,11)]heptasiloxane; endo-3,7,14-tris {dimethyl[2-(5-norbornen-2-yl)ethyl]silyloxy}-1,3,5,7,9,11,14-heptacyclopentyltricyclo[7.3.3.1(5,11)]heptasiloxane; tris((dimethyl(trifluoromethyl)ethyl)silyloxy)heptacyclopentyltricycloheptasiloxane; 3,7,14-tris{[3-(epoxypropoxy)propyl]dimethylsilyloxy}-1,3,5,7,9,11,14-heptacyclopentyltricyclo[7.3.3.1(5,11)]heptasiloxane, and the like.

A combination of the silsesquioxanes with an open cage structure or closed cage structure can be used as the silsesquioxane in conjunction with a combination of any of the reactive nanoparticles.

In an embodiment, a combination of at least two different reactive nanoparticles is used. In a particular embodiment, a silsesquioxane is combined with a second reactive nanoparticle that is different than the silsesquioxane. The silsesquioxane and second reactive nanoparticle can interact in various ways, including physical adsorption, chemisorption, and the like. In some embodiments, the silsesquioxane is bonded to the second nanoparticle. In another embodiment, the silsesquioxane and second reactive nanoparticle are electrostatically attracted to one another. In one embodiment, the silsesquioxane can react with the second reactive nanoparticle to form a bond (e.g., a covalent, ionic, or hydrogen bond) therebetween. In a particular embodiment, the silsesquioxane and second reactive nanoparticles interact via a functional group, through either bonding or electrostatics. Furthermore, any number of silsesquioxanes can be physisorbed or chemisorbed to any number of second reactive nanoparticles, in any order or structural geometry.

In another embodiment, the reactive nanoparticles are bonded to another component in the nanocomposite, including the resin or reactive functional groups that may be present in the resin. Such bonding between the reactive nanoparticles and resin improves tethering of the reactive nanoparticles to the resin. In an embodiment, the silsesquioxane is bonded to the resin. In another embodiment, a second reactive nanoparticle is bonded to the resin. In yet another embodiment, the silsesquioxane and second reactive nanoparticles are both bonded to the resin. In a further embodiment, a reactive nanoparticle can have a degree of derivatization that varies from 1 functional group for every 5 carbon centers to 1 functional group for every 100 carbon centers depending on the functional group.

In a particular embodiment, before combining the reactive nanoparticles and resin, a silsesquioxane and second reactive nanoparticle (e.g., graphene) are mixed or bonded together. Reaction conditions include a temperature or pressure effective to bond the silsesquioxane to the second reactive nanoparticle. In an embodiment, the temperature is 35° C. to 250° C., and specifically 25° C. to 125° C. The pressure can be less than 1 atmosphere (atm) to 10 atm, specifically 1 atm to 7 atm, and more specifically 1 atm to 3 atm. A catalyst can be added to increase the reaction rate of bonding the silsesquioxane to the second reactive nanoparticle. In an embodiment, a silicon atom of the cage structure of the silsesquioxane is bonded directly to the second reactive nanoparticle. In another embodiment, a functional group attached to the silsesquioxane or second reactive nanoparticle is used to bond the silsesquioxane to the second reactive nanoparticle. In one embodiment, the functional group is attached to the silsesquioxane prior to reaction. In another embodiment, the functional group is attached to the second reactive nanoparticle prior to reaction. Thus, in some embodiments, a functional group intercedes between the silsesquioxane and second reactive nanoparticle to bond the silsesquioxane to the second reactive nanoparticle. In a further embodiment, no functional group intercedes between the silsesquioxane and second reactive nanoparticle such that the silsesquioxane and second reactive nanoparticle are bonded directly to one another.

According to an embodiment, the reactive nanoparticles react with a resin and curing agent. The resin, such as an epoxy resin, can be a monomer that forms a polymer (e.g., a thermosetting plastic), oligomer, or a polymer having a reactive functional group. The resin can include a thermoset, thermoplastic, or a combination thereof. Moreover, the nanocomposite can include a blend of polymers, copolymers, terpolymers, or combinations comprising at least one of the foregoing resins. The resin can also contain an oligomer, homopolymer, copolymer, block copolymer, alternating block copolymer, random polymer, random copolymer, random block copolymer, graft copolymer, star block copolymer, dendrimer, or the like, or a combination comprising at last one of the foregoing.

A “thermoset” solidifies when first heated under pressure, and thereafter may not melt or mold without destroying the original characteristics. Thermosetting materials can include epoxides, phenolics, melamines, ureas, polyurethanes, polysiloxanes, polymers including a suitable crosslinkable functional moiety, or a combination comprising at least one of the foregoing.

A thermoplastic has a macromolecular structure that repeatedly softens when heated and hardens when cooled. Illustrative examples of thermoplastic polymeric materials include olefin-derived polymers, for example, polyethylene, polypropylene, and their copolymers; polymethylpentane-derived polymers, for example, polybutadiene, polyisoprene, and their copolymers; polymers of unsaturated carboxylic acids and their functional derivatives, for example, acrylic polymers such as poly(alkyl acrylates), poly(alkyl methacrylate), polyacrylamides, polyacrylonitrile, and polyacrylic acid; alkenylaromatic polymers, for example polystyrene, poly-alpha-methylstyrene, polyvinyltoluene, and rubber-modified polystyrenes; polyamides, for example, nylon-6, nylon-66, nylon-11, and nylon-12; polyesters, such as, poly(alkylene dicarboxylates), e.g., poly(ethylene terephthalate) (hereinafter sometimes designated “PET”), poly(1,4-butylene terephthalate) (hereinafter sometimes designated “PBT”), poly(trimethylene terephthalate) (hereinafter sometimes designated “PTT”), poly(ethylene naphthalate) (hereinafter sometimes designated “PEN”), poly(butylene naphthalate) (hereinafter sometimes designated “PBN”), poly(cyclohexanedimethanol terephthalate), poly(cyclohexanedimethanol-co-ethylene terephthalate) (hereinafter sometimes designated “PETG”), and poly(1,4-cyclohexanedimethyl-1,4-cyclohexanedicarboxylate) (hereinafter sometimes designated “PCCD”), and poly(alkylene arenedioates); polycarbonates; co-polycarbonates; co-polyestercarbonates; polysulfones; polyimides; polyarylene sulfides; polysulfide sulfones; and polyethers such as polyarylene ethers, polyphenylene ethers, polyethersulfones, polyetherimides, polyetherketones, polyetheretherketones; or blends or copolymers thereof.

In a specific embodiment, the resin is an epoxy resin that is a monomer, oligomer, or polymer containing an epoxy functional group, which reacts with the reactive nanoparticle or curing agent to form a reaction product in the nanocomposite. In a particular embodiment, the functional group is a glycidyl group. According to an embodiment, the epoxy resin herein includes an average epoxy functionality of 2 or more epoxy groups per molecule, specifically 3 or more epoxy groups, and more specifically 4 or more epoxy groups. In some embodiments, the epoxy resin has an average of from 2 to 3 epoxy groups per molecule. The epoxy resin can be a saturated or unsaturated aliphatic, cycloaliphatic, aromatic, or heterocyclic compound that has an epoxy group. The epoxy resin can be substituted with a substituent group, e.g., a halogen, hydroxyl, ether, alkyl, and the like. Moreover, the epoxy resin can be a monoepoxide, diepoxide, polyepoxide, or a combination thereof. The epoxy resin can be prepared, e.g., by reaction of diglycidyl ethers of dihydric phenols with dihydric phenols or by reaction of dihydric phenols with epichlorohydrin. Glycidyl ether groups for reaction with a bisphenol include, e.g., butyl glycidyl ether, C8 to C14 aliphatic monoglycidyl ether, cresyl glycidyl ether, neopentyl glycol diglycidyl ether, or a combination thereof. Alternatively, the epoxy resin can be prepared by reaction of a hydroxyl, carboxyl, or amine containing compound with epichlorohydrin, optionally in the presence of a basic catalyst such as a metal hydroxide, e.g., sodium hydroxide. Another route to obtain an epoxy resin is by reaction of a carbon-carbon double bond in an olefin with a peroxide, e.g., a peroxyacid.

According to an embodiment, the epoxy resin includes, for example, a diglycidyl ether of a polyhydric phenol such as resorcinol, catechol, hydroquinone, bisphenol A, bisphenol AP, bisphenol F, bisphenol K, tetramethylbisphenol; diglycidyl ether of an aliphatic glycol or polyether glycol such as the diglycidyl ether of a C₂ to C₂₄ alkylene glycol, poly(ethylene oxide), or poly(propylene oxide)glycol; polyglycidyl ether of phenol-formaldehyde novolac resin; alkyl-substituted phenol-formaldehyde resin (epoxy novalac resins); phenol-hydroxybenzaldehyde resin; cresol-hydroxybenzaldehyde resin; dicyclopentadiene-phenol resin; dicyclopentadiene-substituted phenol resin; or a combination comprising at least one of the foregoing.

In an embodiment, the epoxy resin is a multifunctional epoxy resin that cures to form a nanocomposite with high chemical resistance. Multifunctional epoxy resins include, for example: bisphenol epoxy resins (i.e., resins containing a bisphenol core structure with a pendant epoxy functional group), glycidyl ether epoxy resins, or aliphatic epoxy resins. Bisphenol epoxy resins can be derived from bisphenols such as 2,2-bis(4-hydroxyphenyl)propane (bisphenol A); 1,1-bis(4-hydroxyphenyl)-1-phenyl-ethane (bisphenol AP); 2,2-bis(4-hydroxyphenyl)hexafluoropropane (bisphenol AF); 2,2-bis(4-hydroxyphenyl)butane (bisphenol B); bis-(4-hydroxyphenyl)diphenylmethane (bisphenol BP); 2,2-bis(3-methyl-4-hydroxyphenyl)propane (bisphenol C); bis(4-hydroxyphenyl)-2,2-dichlorethylene (bisphenol D); 1,1-bis(4-hydroxyphenyl)ethane (bisphenol E); bis(4-hydroxydiphenyl)methane (bisphenol F); 2,2-bis(4-hydroxy-3-isopropyl-phenyl)propane (bisphenol G); 1,3-bis(2-(4-hydroxyphenyl)-2-propyl)benzene (bisphenol M); bis(4-hydroxyphenyl)sulfone (bisphenol S); 1,4-bis(2-(4-hydroxyphenyl)-2-propyl)benzene (bisphenol P); 5,5′-(1-methylethyliden)-bis[1,1′-(bisphenyl)-2-ol]propane (bisphenol PH); 3,3,5-trimethylcyclohexanone 1,1-Bis(4-hydroyphenyl)-3,3,5-trimethyl-cyclohexane (bisphenol TMC); 1,1-bis(4-hydroxyphenyl)-cyclohexane (bisphenol Z), and the like.

Exemplary diglycidyl ethers of dihydric phenols include bisphenol A, bisphenol K, bisphenol F, bisphenol S, bisphenol AD, or a combination thereof. Such epoxy resins are commercially available from Dow Chemical Company under the trade name DER 317, DER 331, DER 364, DER 383, DER 661, DER 662, DER 664 DER 667, and the like. The epoxy resin can be substituted with a group such as a halogen, e.g. bromine, attached to a phenyl ring of a bisphenol moiety that is commercially available from Dow Chemical Company under the trade names DER 542 or DER 560. Commercially available diglycidyl ethers of polyglycols include DER. 732 or DER 736 available from Dow Chemical Company. Epoxy novolac resins include cresol-formaldehyde novolac epoxy resins, phenol-formaldehyde novolac epoxy resins and bisphenol A novolac epoxy resins, including those available commercially as DEN 354, DEN 431, DEN 438, or DEN 439, from Dow Chemical Company.

In another embodiment, the epoxy resin is a cycloaliphatic epoxide. Such cycloaliphatic epoxides include a saturated carbon ring having an epoxy oxygen bonded to two adjacent carbon atoms of the carbon ring. Exemplary cycloaliphatic epoxy resins include (3,4-epoxycyclohexyl-methyl)-3,4-epoxy-cyclohexane carboxylate; bis-(3,4-epoxycyclohexyl)adipate; vinylcyclohexene monoxide; 3-(1,2-epoxyethyl)-7-oxabicyclo heptane; hexanedioic acid, bis(7-oxabicyclo heptylmethyl)ester; 2-(7-oxabicyclohept-3-yl)-spiro(1,3-dioxa-5,3′-(7)-oxabicyclo heptane); methyl-3,4-epoxycyclohexane carboxylate; 3-cyclohexenylmethyl-3-cyclohexenylcarboxylate diepoxide; 2-(3,4-epoxy)cyclohexyl-5,5-spiro-(3,4-epoxy)cyclohexane-m-dioxane; 3,4-epoxycyclohexylalkyl-3,4-epoxycyclohexanecarboxylate; 3,4-epoxy-6-methylcyclohexylmethyl-3,4-epoxy-6-methylcyclohexanecarboxylate; vinyl cyclohexanedioxide, bis(3,4-epoxycyclohexylmethyl)adipate; bis(3,4-epoxy-6-methylcyclohexylmethyl)adipate, exo-exo bis(2,3-epoxycyclopentyl)ether; endo-exo bis(2,3-epoxycyclopentyl)ether; 2,2-bis(4-(2,3-epoxypropoxy)cyclohexyl)propane; 2,6-bis(2,3-epoxypropoxycyclohexyl-p-dioxane); 2,6-bis(2,3-epoxypropoxy)norbornene; diglycidylether of linoleic acid dimer; limonene dioxide; 2,2-bis(3,4-epoxycyclohexyl)propane; dicyclopentadiene dioxide; 1,2-epoxy-6-(2,3-epoxypropoxy)-hexahydro-4,7-methanoindane; p-(2,3-epoxy)cyclopentylphenyl-2,3-epoxypropylether; 1-(2,3-epoxypropoxy)phenyl-5,6-epoxyhexahydro-4,7-methanoindane; o-(2,3-epoxy)cyclopentylphenyl-2,3-epoxypropyl ether); 1,2-bis(5-(1,2-epoxy)-4,7-hexahydromethanoindanoxyl)ethane; cyclopentenylphenyl glycidyl ether; cyclohexanediol diglycidyl ether; butadiene dioxide; dimethylpentane dioxide; diglycidyl ether; 1,4-butanedioldiglycidyl ether; diethylene glycol diglycidyl ether; dipentene dioxide; diglycidyl hexahydrophthalate; 5,10-dioxatricyclo[7.1.0.04,6]decane; and the like. In a specific embodiment, the cycloaliphatic epoxy resin is 3-cyclohexenylmethyl-3-cyclohexenylcarboxylate diepoxide.

Exemplary aliphatic epoxy resins include epoxy resins that contain an aliphatic group, including C4 to C20 aliphatic or polyglycol chains such as butadiene dioxide, dimethylpentane dioxide, diglycidyl ether, 1,4-butanedioldiglycidyl ether, diethylene glycol diglycidyl ether, dipentene dioxide, and the like. Commercially available aliphatic epoxy resins are, e.g., DER 732 and DER 736 from Dow Chemical Company.

Other commercially available epoxy resins include, for example Epikote 807, Epikote 815, Epikote 825, Epikote 827, Epikote 828, Epikote 190P, and Epikote 191P (manufactured by Yuka Shell Epoxy Co., Ltd.); Epikote 1004, Epikote 1256, YX8000 (manufactured by Japan Epoxy Co., Ltd.); Araldiate 8615, Araldite CY177, Araldite CY184 (manufactured by Huntsman Intl. LLC); Clloxide 2021P, EHPE-3150 (manufactured by Daicel Chemical Industries, Ltd.); Techmore VG3101L (manufactured by Mitsui & Co., Ltd.); Epikote 871, Epikote 872, Epikote 4250, Epikote 4275 (manufactured by Japan Epoxy Resin Co., Ltd.); Epiclon TSR-960, Epiclon TSR-601, Epiclon TSR-250-80BX, Epiclon 1600-75X (manufactured by DIC Inc.); YD-171, YD-172, YD-175×75, PG-207, ZX-1627, YD-716 (manufactured by Nippon Steel Chemical Co., Ltd.); Adeka Resin EP-4000, Adeka Resin EP-40005, Adeka Resin EPB 1200 (manufactured by Adeka Corp.); EX-832, EX-841, EX-931, Denarex R-45EPT (manufactured by Nagase ChemteX Corp.); BPO-20E, BPO-60E (manufactured by New Japan Chemical Co.); Epolight 400E, Epolight 400P, Epolight 3002 (manufactured by Kyoeisha Chemical Co., Ltd.); SR-8EG, SR-4PG (manufactured by Sakamoto Pharmaceutical Co.); Heloxy 84, Heloxy 505 (manufactured by Hexion Specialty Chemicals, Inc.); SB-20G, IPU-22G (manufactured by Okamura Oil Mill, Ltd.); Epolead PB3600 (manufactured by Daicel Chemical Industries, Ltd.); EPB-13 (manufactured by Nippon Soda Co., Ltd.); and the like.

In a specific embodiment, the epoxy resin is triglycidyl-p-aminophenol, bis[4-(2,3-epoxypropoxy)phenyl]propane, N,N,N′,N′-tetraglycidyl-4,4′-diaminodiphenylmethane, butanedioldiglycidyl ether, or a combination comprising at least one of the foregoing.

In an embodiment, a curing agent is added to the reactive nanoparticles and resin to form a composition. The curing agent can be a hardener, accelerator, catalyst, curative, initiator, and the like, or a combination comprising at least one of the foregoing. It is believed that the curing agent reacts with functional groups such as epoxy groups located within the composition in various ways that may include crosslinking, adding to a polymer backbone, or capping a polymer. The curing agent includes an amine, amide, phenol, thiol, carboxylic acid, anhydride, alcohol, or a combination comprising at least one of the foregoing. These curing agent can enhance properties such as heat and chemical resistance of the resulting nanocomposite and consolidations therefrom. The curing agent can be selected based on the resin or reactive nanoparticles as well as the desired properties of the nanocomposite.

The amine curing agent includes a primary, secondary, or tertiary amine, ammonium salt, and the like. Exemplary amine curing agents are 1,2-diaminoethane, 1,3-cyclohexanedimethanamine, 2,2′-dimethyl-4,4′ methylenebis(cyclohexylamine), 2,4,6-tris(dimethylaminomethyl)phenol, 2-methylpentamethylenediamine, 2-piperazin-1-ylethylamine, 3-aminomethyl-3,5,5-trimethylcyclohexylamine, 3-aminopropyldimethylamine, 4,4′-diaminodiphenylmethane, 4,4′-methylenebis(cyclohexylamine), benzyldimethylamine, bis[(dimethylamino)methyl]phenol, 1,3-benzenedimethanamine, N(3-dimethylaminopropyl)-1,3-propylenediamine, octahydro-4,7-methano-1H-indenedimethylamine, tetraethylenepentamine, isophoronediamine, triethylenetetraamine, diethylenetriamine, aminoethylpiperazine, 1,2-diaminopropane, 1,3-diaminopropane, 2,2-dimethylpropylenediamine, 1,4-diaminobutane, 1,6-diaminohexane, 1,7-diaminoheptane, 1,8-diaminooctane, 1,9-diaminonane, 1,12-diaminododecane, 4-azaheptamethylenediamine, N,N′-bis(3-aminopropyl)butane-1,4-diamine, cyclohexanediamine, dicyandiamine, diamide diphenylmethane, diamide diphenylsulfonic acid (amine adduct), 4,4′-methylenedianiline, diethyltoluenediamine, m-phenylene diamine, melamine formaldehyde, tetraethylenepentamine, 3-diethylaminopropylamine, 3,3′-iminobispropylamine, 2,4-bis(p-aminobenzyl)aniline, tetraethylenepentamine, 3-diethylaminopropylamine, 2,2,4-trimethylhexamethylenediamine, 2,4,4-trimethylhexamethylenediamine, 1,2-trimethylhexamethylenediamine, 1,3-diaminocyclohexane, 1,4-diamino-3,6-diethylcyclohexane, 1,2-diamino-4-ethylcyclohexane, 1,4-diamino-3,6-diethylcyclohexane, 1-cyclohexyl-3,4-dimino-cyclohexane, 4,4′-diaminodicyclohexylmethane, 4,4′-diaminodicyclohexylpropane, 2,2-bis(4-aminocyclohexyl)propane, 3,3′-dimethyl-4,4′-diaminodicyclohexylmethane, 3-amino-1-cyclohexaneaminopropane, 1,3-bis(aminomethyl)cyclohexane, 1,4-bis(aminomethyl)cyclohexane, m-xylylendiamine, p-xylylendiamine, and the like.

Exemplary anhydride curing agents include maleic anhydride, tetrahydrophthalic anhydride, hexahydrophthalic acid, methyltetrahydrophthalic anhydride, methylhexahydrophthalic anhydride, 1,2-cyclohexanedicarboxylic anhydride, bicyclo[2.2.1]hept-5-ene-2,3-dicarboxylic anhydride, methylbicyclo[2.2.1]hept-5-ene-2,3-dicarboxylic anhydride, phthalic anhydride, pyromellitic dianhydride, hexahydrophthalic anhydride, dodecenylsuccinic anhydride, dichloromaleic anhydride, chlorendic anhydride, tetrachlorophthalic anhydride, trimellitic anhydride, hexahydrotrimellitic anhydride, methylnadic anhydride, hydro methylnadic anhydride, dodecenyl succinic anhydride, hexahydropyromellitic dianhydride, benzophenonetetracarboxylic dianhydride, styrene-maleic anhydride copolymers, dodecyl succinic anhydride, and the like.

Exemplary isocyanate curing agents include toluene diisocyanate, methylene diphenyldiisocyanate, hydrogenated toluene diisocyanate, hydrogenated methylene diphenyldiisocyanate, polymethylene polyphenylene polyisocyanates, isophorone diisocyanate, and the like.

Thiol curing agents include polythiol or polymercaptan compounds. In an embodiment, the thiol curing agent is an alkyl polysulfide, thiuram disulfide, or amine polysulfide. Some non-limiting examples of the thiol curing agent are 4,4′-dithiomorpholine, dithiodiphosphorodisulfides, diethyldithiophosphate polysulfide, alkyl phenol disulfide, tetramethylthiuram disulfide, 4-morpholinyl-2-benzothiazole disulfide, dipentamethylenethiuram hexasulfide, and caprolactam disulfide. Additional exemplary thiol curing agents include aliphatic thiols such as methanedithiol, propanedithiol, cyclohexanedithiol, 2-mercaptoethyl-2,3-dimercapto-succinate, 2,3-dimercapto-1-propanol(2-mercaptoacetate), diethylene glycol bis(2-mercaptoacetate), 1,2-dimercaptopropyl methyl ether, bis(2-mercaptoethyl)ether, trimethylolpropane tris(thioglycolate), pentaerythritol tetra(mercaptopropionate), pentaerythritol tetra(thioglycolate), ethyleneglycol dithioglycolate, trimethylolpropane tris(beta-thiopropionate), tris-mercaptan derivative of tri-glycidyl ether of propoxylated alkane, or dipentaerythritol poly(beta-thiopropionate); halogen-substituted derivatives of aliphatic thiols; aromatic thiols such as di-, tri- or tetra-mercaptobenzene, bis-, tris- or tetrakis(mercaptoalkyl)benzene, dimercaptobiphenyl, toluenedithiol, or naphthalenedithiol; halogen-substituted derivatives of aromatic thiols; heterocyclic ring-containing thiols such as amino-4,6-dithiol-sym-triazine, alkoxy-4,6-dithiol-sym-triazine, aryloxy-4,6-dithiol-sym-triazine, or 1,3,5-tris(3-mercaptopropyl) isocyanurate; halogen-substituted derivatives of heterocyclic ring-containing thiols; thiol compounds having at least two mercapto groups and containing sulfur atoms in addition to the mercapto groups such as bis-, tris- or tetra(mercaptoalkylthio)benzene, bis-, tris- or tetra(mercaptoalkylthio)alkane, bis(mercaptoalkyl)disulfide, hydroxyalkylsulfidebis(mercaptopropionate), hydroxyalkylsulfidebis(mercaptoacetate), mercaptoethyl ether bis(mercaptopropionate), 1,4-dithian-2,5-diolbis(mercaptoacetate), thiodiglycolic acid bis(mercaptoalkyl ester), thiodipropionic acid bis(2-mercaptoalkyl ester), 4,4-thiobutyric acid bis(2-mercaptoalkyl ester), 3,4-thiophenedithiol, bismuththiol or 2,5-dimercapto-1,3,4-thiadiazol; and the like.

Exemplary phenol curing agents include hydroquinone, catechol, resorcinol, phloroglucinol, pyrogallol, 1,6-dihydroxy naphthalene, 2,7-dihydroxy naphthalene, 2,6-dihydroxy naphthalene, 1,2,4-trihydroxybenzene, 1,3-dihydroxy naphthalene, 1,4-dihydroxy naphthalene, 1,5-dihydroxy naphthalene, 1,7-dihydroxy naphthalene, 2,3-dihydroxy naphthalene, 1,2-dihydroxy naphthalene, 2-methylresorcinol, 5-methylresorcinol, hexahydroxybenzene, 1,8,9-trihydroxyanthracene, 3-methyl-pyrocatecho, methyl-hydroquinon, 4-methyl-pyrocatecho, 4-benzylresorcinol, 1,1′-bis(2-naphthol), 4,4′-bisphenol, bis(4-hydroxyphenyl)sulfone, and 4-bromoresorcinol, 4,4′-butylidenebis(6-tert-butyl-3-m-cresol), 4-tert-butylcatechol, 2,2′-bisphenol, 4,4′-dihydroxydiphenylmethane, tert-butylhydroquinone, 1,3-bis(4-hydroxyphenoxy)benzene, 1,4-bis(3-hydroxyphenoxy)benzene, 1,1-bis(4-hydroxylphenyl)cyclohexane, bis(4-hydroxyl-3,5-dimethylphenyl)sulfone, 9,9-bis(4-hydroxyphenyl)fluorine), 9,9-bis(4-hydroxyl-3-methylphenyl)fluorine, 4-tert-butyl calix[8]arene, 4-tert-butyl calix[5]arene, 4-tert-butylsulfonyl calix[4]arene, calix[8]arene, calix[4]arene, calix[6]arene, and 4-tety-butyl calix[6]arene, 2,5-bis(1,1,3,3,-tetramethylbutyl)hydroquinone, 2,6-bis[(2-hydroxyl-5-methylphenol)methyl]-4-methylphenol, 1,1-bis(3-cyclohexyl-4-hydroxylphenol)cyclohexane, 1,1-bis(4-hydroxyl-3-methylphenol)cyclohexane, hexestrol, 2′,4′-dihydroxyacetophenone, anthrarufin, chrysazin, 2,4-dihydroxybenzaldehyde, 2,5-dihydroxybenzaldehyde, 3,4-dihydroxybenzaldehyde, ethyl 3,4-dihydroxyaminobenzoate, 2,4-dihydroxybenzophenone, 2,2′-dihydroxy-4,4′-dimethoxy-benzophenone, 4,4′-dihydroxybenzophenone, 4-ethylresorcinol, and phenylhydroquinone, 2,2′-dihydroxy-4-methoxybenzophenone, 2,2′-dihydroxybenzophenone, methyl 2,6-dihydroxyaminobenzoate, 2,3-dihydroxybenzaldehyde, octafluoro-4,4′-bisphenol, 3′,6′-dihydroxybenzoylnorbornene, 2,4′-dihydroxydiphenylmethane, 2′,5′-dihydroxyacetophenone, 3′,5′-dihydroxyacetophenone, 2,4-dihydroxyaminobenzoate, 2-hydroxyethyl-4,4′-dihydroxydiphenyl etherdihydroxydiphenyl ether, 2,2′-dihydroxydiphenyl ether, methyl 3,5-dihydroxyaminobenzoate, 1,4-dihydroxy-2-naphthoate, 3′,4′-dihydroxyacetophenone, 2,4′-dihydroxydiphenyl sulfone, 3,4′-dihydroxybenzyl alcohol, 3,5-dihydroxybenzyl alcohol, 2,4′-dihydroxybenzophenone, 2,6′-dimethyl hydroquinone, 2′,4′-dihydroxypropiophenone, 4,4′-dihydrxytetraphenylmethane, methyl 3,4-dihydroxyphenylacetate, 2,5-dimethylresorcinol, 2-(3,4-dihydroxyphenyl)ethanol, 4,4′-ethylidene bis-phenol, 3,3′-ethylenedioxydiphenol, 4-fluorocatechol, ethyl gallate, methyl gallate, propyl gallate, isoamyl gallate, hexadecyl gallate, dodecyl gallate, stearyl gallate, butyl gallate, isobutyl gallate, n-octyl-4-hexylresorcinol gallate, 4,4′-(2-hydroxybenzilidene)bis(2,3,6-trimethylphenol), 4,4′-methylene-bis-(2,6-di-tert-butylphenol), 2,2′-methylene-bis(6-tert-butyl-4-ethyl phenol), 2,2′-methylene-bis(6-tert-butyl-4-cresol), methoxyhydroquinone, 4,4′-(.alpha.-methylbenzal)bisphenol, 4,4′-methylene-bis(2,6-dimethylphenol), 2,2′-methylene-bis(4-methylphenol), 5-methoxyresorcinol, 2,2′-methylene-bis[6-(2-hydroxy-5-methylbenzyl)-p-cresol, 4,4′-methylene-bis(2-methylphenol), methyl 2,4-dihydroxyaminobenzoate, 2,2′-methylene-bis(6-cyclohexyl-p-cresol), methyl 3,4-dihydroxyaminobenzoate, and 2,5-dihydroxyaminobenzoate, 2,2′,4,4′-tetrahydroxybenzophenone, 2,4,4′-trihydroxybenzophenone, 5-methylpyrogallol, 2′,4′,6′-trihydroxypropiophenone, 2,3,4-trihydroxybenzophenone, 2′,3′,4′-trihydroxyacetophenone, 1,1,1-tris(4-hydroxyphenol)ethane, 2,3′,4,4′-tetrahydroxybenzophenone, 4,4′,4″-trihydroxytriphenylmethane, 2,3,4,4′-tetrahydroxybenzophenone, 2,3,4,4′-tetrahydroxydiphenylmethane, 5,5′,6,6′-tetrahydroxy-3,3,3′,3′-tetramethyl-1,1′-spirobiindane, 2,4,5-trihydroxybenzaldehyde, 6,6′,7,7′-tetrahydroxy-4,4,4′4′-tetramethylspirobicromane, tetrafluoro-hydroquinone, 2,3,4-trihydroxybenzaldehyde, 2,2-bis(4-hydroxyphenyl)propane, 2,2-bis(4-hydroxyphenyl)hexafluoropropane, 2,2-bis(2-hydroxy-5-biphenyl)propane, 2,2-bis(3-cyclohexyl-4-hydroxyphenyl)propane, 2,2-bis(3-sec-butyl-4-hydroxyphenyl)propane, 2,2-bis(4-hydroxy-3,5-dimethylphenyl)propane, 2,2-bis(4-hydroxy-3-isopropylphenyl)propane, 2,2-bis(4-hydroxy-3-methylphenyl)propane, and the like.

Other curing agents include boron trihalide amine adducts of amines such as monoethanolamine, diethylamine, dioctylmethylamine, triethylamine, pyridine, benzylamine, benzyldimethyl amine, and the like. Additional curing agents include phosphine compounds, such as tributylphosphine, triphenylphosphine, tris(dimethoxyphenyl)phosphine, tris(hydroxypropyl)phosphine and tris(cyanoethyl)phosphine; phosphonium salts, such as tetraphenylphosphonium tetraphenylborate, methyltributylphosphonium tetraphenylborate and methyltricyanoethyl phosphonium tetraphenylborate; and the like.

According to an embodiment, the curing agent acts as a time-delay catalyst. That is, the amount of the catalyst present with the resin and reactive nanoparticles is variable, and depending on the amount of the curing agent, the resin and reactive nanoparticles cure at various rates. Thus, a relatively slow curing rate can occur by introducing the curing agent in a first amount. Alternatively, a relatively faster curing rate can be selected by introducing the curing agent in a second amount. As a result, in some embodiments, the curing rate of the resin and reactive nanoparticles is controlled by the amount of the curing agent present.

In an embodiment, the nanocomposite (formed by curing the resin, reactive nanoparticles, and curing agent) also includes an additive. In a specific embodiment, the additive is added to the resin, reactive nanoparticles, or curing agent prior to curing. The additive can strengthen the nanocomposite bonded to the particles or increase the porosity of the nanocomposite to allow an increased flow rate of a fluid, e.g., crude oil, through the nanocomposite. An additive, as used herein, includes a reinforcing or non-reinforcing additive. Reinforcing additives include, for example, bauxite, alumina, metal, metal oxide, silica, glass fiber, glass bead, carbon fiber, or carbon black, diamond, boron nitride boron carbide, aluminum nitride, which can be added to the nanocomposite to increase strength. The metal can be, e.g., tungsten, titanium, molybdenum, niobium, vanadium, hafnium, zirconium, silicon, tantalum, chromium, iron, manganese, aluminum, magnesium, calcium, carbides thereof, oxides thereof, borides, thereof, and the like.

Non-reinforcing additives such as polytetrafluoroethylene (PTFE), molybdenum disulfide (MoS₂), or graphite can be added to the composition to increase lubrication, prior to curing. Other additives, such as a carbon nanotubes, nanoclays, or the like, can be incorporated into the composition to increase the strength or elongation of the nanocomposite. The additives can further be functionalized to include grafts or functional groups to adjust properties such as solubility, surface charge, hydrophilicity, lipophilicity, and other properties of the composition prior to curing and to provide beneficial surface properties to the nanocomposite. Combinations comprising at least one of the foregoing additives can be used. The additives can be present in the nanocomposite in an amount from 0.5 wt % to 70 wt %, specifically 0.5 wt % to 50 wt %, and more specifically 0.5 wt % to 25 wt %, based on the weight of the nanocomposite.

In the composition, a total amount of the reactive nanoparticles and curing agent can be from 1 wt % to 80 wt %, specifically 1 wt % to 70 wt %, and more specifically 1 wt % to 50 wt %, based on a weight of the composition. The reactive nanoparticles can be present in the composition in an amount from 0.1 wt % to 90 wt %, specifically 0.1 wt % to 75 wt %, and more specifically 1 wt % to 30 wt %, based on a weight of the composition. A ratio of the weight of the silsesquioxane to that of the second reactive nanoparticle in the composition can be from 1:500 to 500:1, specifically 1:300 to 300:1, more specifically 1:100 to 100:1, and even more specifically 1:50 to 50:1.

In an embodiment, an amount of the curing agent present with the resin and reactive nanoparticles is selected to control the rate of curing. The curing agent can be present in the composition in an amount from 0.05 wt % to 60 wt %, specifically 0.5 wt % to 40 wt %, and more specifically 0.5 wt % to 30 wt %, based on the weight of the composition. The resin can be present in the composition in an amount from 30 wt % to 99 wt %, specifically 40 wt % to 99 wt %, and more specifically 50 wt % to 99 wt %, based on the weight of the composition. In some embodiments, the amount of the resin is adjusted to correspond to a molar amount of another component of the composition such as the reactive nanoparticles, curing agent, or a functional group thereof, e.g., an amine group attached to the reactive nanoparticles or curing agent. In a particular embodiment, the a molar ratio of a number of moles of an epoxy functional group of the epoxy resin to the sum of the number of moles of the reactive nanoparticles and curing agent is from 1:1 to 100:1, specifically 1:1 to 50:1, and more specifically 1:1 to 10:1.

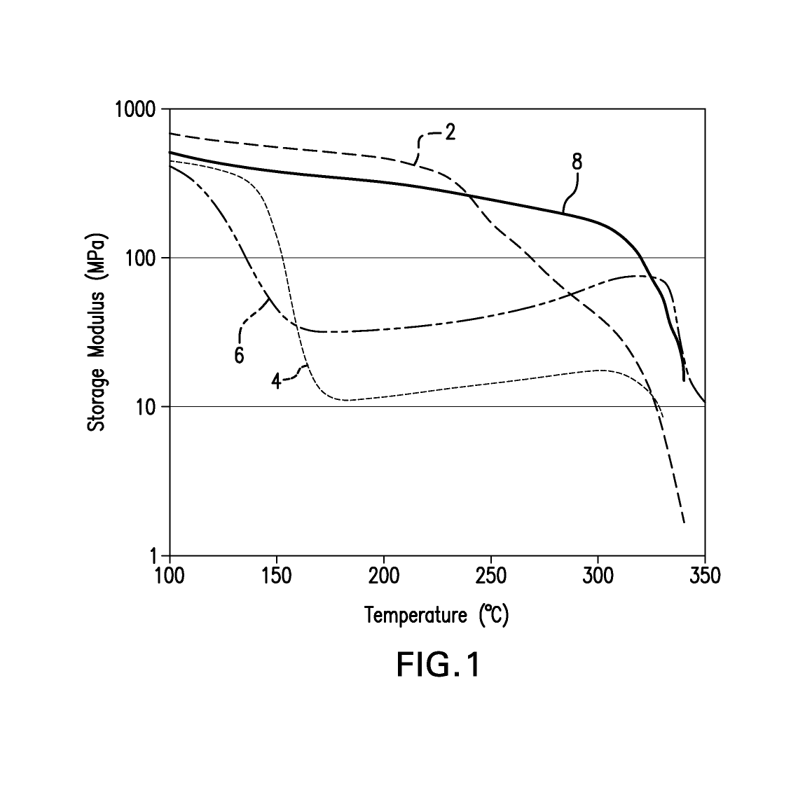

The relative amount of reactive nanoparticles, resin, and curing agent in the composition determine the properties of the nanocomposite. As shown in FIG. 1, the storage modulus for a nanocomposite of an epoxy resin reacted with a first amount of a curing agent is plotted as dashed curve 2. Addition of extra curing agent (a second amount, greater than the first amount) to the epoxy resin decreases both the storage modulus and glass transition temperature as indicated by dotted curve 4. Alternatively, combining a silsesquioxane with an epoxy resin and first amount of the curing agent also decreases the storage modulus and glass transition temperature of the nanocomposite as indicated by dashed-dot curve 6. However, as shown by solid curve 8, a combination of epoxy resin, silsesquioxane, and curing agent in an appropriate proportion increases the glass transition temperature and also increases the storage modulus in a temperature range that is greater than the glass transition temperature for any of the nanocomposites represented by curves 2, 4, and 6.

In an embodiment, the relative weight amount of the resin to the curing agent in the composition is less than 2:1, i.e., the weight of the resin in the composition is less than half that of the curing agent. In an embodiment, the ratio of the weight of the resin to curing agent is from 0.1:1 to 1.9:1, specifically, 0.1:1 to 1.8:1, more specifically 0.1:1 to 1.6:1, even more specifically 0.1:1 to 1.4:1, and further more specifically 0.1:1 to 1.2:1. In another embodiment, the ratio of the weight of the silsesquioxane to curing agent is from 0.1:1 to 1.5:1, specifically, 0.1:1 to 1.3:1, more specifically 0.1:1 to 1.1:1, even more specifically 0.1:1 to 0.9:1, and further more specifically 0.1:1 to 0.8:1

In an embodiment, the resin or reactive nanoparticle can be combined with a solvent. The reactive nanoparticles or resin can be dispersed in the solvent, or the solvent can be added to the combination of the reactive nanoparticles and resin. In another embodiment, the process for stabilizing particles includes introducing a solvent prior to curing the resin and reactive nanoparticles with the curing agent. The solvent can promote wettability of particles or remove water or oil from near a borehole region that is subjected to particle consolidation by application and curing of the composition. In some embodiments, the solvent can be introduced subsequent to curing to remove unreacted resin, reactive nanoparticles, curing agent, or a combination thereof.

The solvent is a material in which the resin, reactive nanoparticles, or curing agent is soluble (either fully or partially), at a temperature at which the resin, reactive nanoparticles, and curing agent are combined. In an embodiment, the solvent is not reactive with the resin, reactive nanoparticles, or curing agent under the reactions conditions, such as curing. The solvent can have a boiling point that is equal to or greater than the temperature employed to conduct the curing reaction.

The solvent can be an inorganic solvent such as water, including deionized water, or buffered or pH adjusted water, mineral acid, or a combination comprising at least one of the foregoing, or an organic solvent comprising an alkane, alkene, alcohol, ester, ketone, oils, ether, amide, sulfone, sulfoxide, or a combination comprising at least one of the foregoing. Exemplary inorganic solvents include water, sulfuric acid, hydrochloric acid, or the like; exemplary oils include mineral oil, silicone oil, or the like; and exemplary organic solvents include alkanes such as hexane, heptane, 2,2,4-trimethylpentane, n-octane, cyclohexane, and the like; alcohols such as methanol, ethanol, propanol, isopropanol, butanol, t-butanol, octanol, cyclohexanol, ethylene glycol, ethylene glycol methyl ether, ethylene glycol ethyl ether, ethylene glycol butyl ether, propylene glycol, propylene glycol methyl ether, propylene glycol ethyl ether, and the like; ketones such as acetone, methyl-ethyl ketone, cyclohexanone methyletherketone, 2-heptanone, and the like; esters such as ethyl acetate, propylene glycol methyl ether acetate, ethyl lactate, and the like; ethers such as tetrahydrofuran, dioxane, and the like; polar aprotic solvents such as N,N-dimethylformamide, N-methylcaprolactam, N-methylpyrrolidine, dimethylsulfoxide, gamma-butyrolactone, and the like; alkenes such as butene, benzene, toluene, nitrobenzene, and the like; ethers such as diethyl ether, tert-butyl methyl ester, 3-methoxyhexane, propylene oxide, and the like; sulfones such as sulfolane, dimethyl sulfone, and the like; or a combination comprising at least one of the foregoing. The solvent can be present in an amount from 0.1 wt % to 70 wt %, specifically 1 wt % to 40 wt %, and more specifically 1 wt % to 20 wt %, based on the weight of the composition including resin, reactive nanoparticles, and curing agent.

The combination of reactive nanoparticles and resin can be a liquid, solid, or a combination thereof. According to an embodiment, the reactive nanoparticles and resin are dispersed with one another before being disposed on the particles. The reactive nanoparticles are derivatized with a functional group to facilitate dispersal and reactivity with the resin. In addition, the resin can be derivatized with a functional group to improve the processing with the reactive nanoparticles. To improve mixing, the resin and reactive nanoparticles can be dispersed in a solvent including inorganic solvents like water, or mineral acids such as sulfuric acid, or organic solvents including oils, alcohols and glycols, ketones such as methylethylketone (MEK), ethers such as tetrahydrofuran (THF), polar aprotic solvents such as N,N-dimethylformamide (DMF), dimethylsulfoxide (DMSO), or another solvent.

In another embodiment, the reactive nanoparticles can be formulated as a solution or dispersion and cast or coated, or may be mechanically dispersed in the resin. Dispersion of the reactive nanoparticles and the resin can be accomplished by methods such as, for example, extrusion, blending, high shear mixing, rotary mixing, three-roll milling, solution mixing, and the like. The properties of the nanocomposite can be adjusted by the selection of resin or reactive nanoparticles (or curing agent as below).

Rotational mixing is a mixing method in which the vessel containing the mixing components is rotated about its axis, while simultaneously processing at a fixed radius about a second rotational center. Thus, the vessel precesses to mix the composition. Mixing in this way provides high shear and elimination of bubbles, while avoiding use of agitators which can lead to a non-homogeneous composition that may be caused by, for example, different mixing zones within a mixing vessel or bubbles generated by mixing and cavitation. Use of vacuum in processing can further improve both mechanical properties and (reduced) variability by removing volatile components and any adventitious bubbles that may form during the mixing process. An example of a rotational mixer which can provide suitable mixing of the components (i.e., of the polymer and nanofiller), with or without vacuum, is a THINKY® Rotational Vacuum Mixer AR 310 (available from Thinky, Inc.).

In another embodiment, mixing by a reactive injection molding-type process can be accomplished using two or more continuous feed streams, where the reactive nanoparticles can be included as a component of one of the feed streams (e.g., where the resin is an epoxy prepared using different feed streams, the reactive nanoparticles can be included in an epoxy containing stream or in a separate stream as a suspension in a solvent). Mixing in such systems is accomplished by the flow within the mixing zone at the point of introduction of the components.

According to an embodiment, the reactive nanoparticles are combined with the resin, and then the reactive nanoparticles are bonded to the resin. In a non-limiting embodiment, the reactive nanoparticles and resin are combined, and a crosslinking reaction is initiated. In another embodiment, the reactive nanoparticles are introduced after initiating the crosslinking reaction. In an embodiment, the reactive nanoparticles are mixed with the resin such that a gradient in the concentration of the reactive nanoparticles with respect to the resin is present in a consolidation of particles containing the nanocomposite.

In yet another embodiment, particles can be consolidated by coating the particles with a resin to which reactive nanoparticles are introduced. The resin and reactive nanoparticles are then cured with a curing agent to form a nanocomposite which is bonded to the particles. A rate of the curing can be controlled by an amount of the curing agent that is present with the resin. The resulting nanocomposite bonded to the particles is thermally stable up to at least 600° F. (315° C.).

In another embodiment, the pressure and temperature can be controlled during curing of the composition. In some embodiments, the composition is heated to a temperature from 20° C. to 300° C., specifically 50° C. to 275° C., and more specifically, 75° C. to 250° C. The pressure can be from 1 atm to 10 atm, specifically 1 atm to 7 atm, and more specifically 1 atm to 3 atm. The pressure can be exerted by gases released during the curing, a component of the composition, a gas added to the composition, or an applied hydraulic force that can be part of the environment in which the composition is disposed. In an embodiment, the reaction between the reactive nanoparticle, resin, or curing agent is moderated by selection of the temperature or a temperature program that includes a temperature ramp, temperature soak period, or a combination thereof.

According to an embodiment, the reactive nanoparticle and resin are combined with a curing agent. The composition is held at a temperature, e.g., 20° C. (68° F.) for 24 hours to allow formation of the reaction product (e.g., bonds between reactive nanoparticles, resin, or curing agent). Alternatively, the temperature can be increased to, e.g., 180° C. and maintained there for 3 hours, as an example. In another embodiment, the reactive nanoparticles, resin, and curing agent can be disposed in an mold (e.g., a compression mold) to form the nanocomposite. Such an article can be porous such that the article of the nanocomposite is a filter or membrane. Porosity can be effected by introducing a blowing agent into the composition prior to or during curing. A chemical (e.g., a reactive species) or physical (e.g., a volatile liquid or gas) blowing agent can be incorporated in the composition. According to an embodiment, the article has a porosity effective to communicate a fluid, e.g., crude oil, but inhibit the passage of particles (e.g., sand) therethrough.

In another embodiment, the composition is disposed such that the particles are contacted or coated by the reactive nanoparticles, resin, or curing agent. The composition is cured to bond the nanocomposite to the particles. Steam can be applied to the nanocomposite bonded to the particles, wherein the nanocomposite bonded to the particles is thermally stable at a temperature of the steam. The particles comprise materials from an earth formation or borehole, including sand, rock, heavy oil precipitate (e.g., asphaltene, bitumen, oxidized heavy ends, and the like), gravel pack material, sediment, or a combination of at least one of the foregoing. The particles can be disposed in a borehole, production zone, gravel pack, sand screen, frac vein, formation, perforation, or a combination comprising at least one of the foregoing. Thus, in an embodiment, the reactive nanoparticles, resin, or curing agent is disposed in, e.g., a borehole with a subsequent curing reaction ensuing to produce a nanocomposite bonded to particles in the borehole. In this manner, the particles are immobilized. In a particular embodiment, a borehole is stabilized by the immobilization (also referred to as consolidation) of the particles in or near the borehole. In a further embodiment, the resulting consolidation of particles, i.e., particles bonded to the cured nanocomposite, has a porosity effective to allow flow of a fluid, e.g., crude oil, therethrough, i.e., the fluid is communicated through the pores in the consolidation.

The particles before disposal of the composition can have an initial porosity. After disposal of the composition, a solvent can flush away excess components of the composition so that after curing, the nanocomposite bonded to the particles maintains a pore structure or introduces a new pore structure. In some embodiments, a fluid (e.g., a blowing agent) can be introduced to the composition prior to or during curing to introduce the pore structure. In a particular embodiment, a gas (e.g., nitrogen or carbon dioxide) can pass through the composition and particles to ensure a proper flow rate of fluids in the nanocomposite after curing. As used herein, consolidation refers to the nanocomposite and particles that are bonded together as a result of curing the composition.

According to an embodiment, the pores of the consolidated particles pass fluids. The method can include thermally recovering crude oil that flows through the nanocomposite bonded to the particles. The thermal recovery can include a thermal process such as steam assisted gravity drainage, steam cycling, oil upgrading, in-situ combustion, or a combination comprising at least one of the foregoing. Such thermal processes are enhanced oil recovery methods that involve introduction or production of heat so that a corresponding temperature increase leads to a decrease of the viscosity of the oil, including heavy oil. The temperature of the thermal process is high enough to degrade many conventional polymer-based consolidation systems. However, the nanocomposite herein has a thermal decomposition temperature that withstands the increased temperature and prevents degradation of a particle consolidation that includes the nanocomposite having a cure product of the resin and reactive nanoparticles.

In an embodiment, the consolidation and oil in an environment such as a formation, borehole, etc. can be subjected to an increased temperature that occurs due to electrical heating, in-situ combustion, steam flooding, cyclic steam stimulation, steam assisted gravity drainage, and the like. During cyclic steam stimulation, high pressure steam is injected into the environment with subsequent soaking for a period of time to diffuse the administered heat. Steam flooding also includes injection of steam, which increases the temperature of the environment and can increase the pressure of the environment to urge oil down the pressure gradient away from the high-pressure source, e.g., toward a production site.

In-situ combustion can involve the injection of gases that contain oxygen (e.g., air, steam, and the like) that allows local combustion of hydrocarbons in a formation in order for heat to be produced, which radiates from a combustion zone. In one embodiment, in-situ combustion includes combustion of heavy oil or coke in a formation to provide heat to mobilize oil. In a specific embodiment, the hydrocarbon present in a downhole formation can be ignited using injected air or another oxygen source (including pure oxygen, steam, and the like) in the oil environment. Increasing the temperature includes techniques that can elevate the temperature from 150° C. to 1200° C., specifically 200° C. to 1000° C., and more specifically 300° C. to 800° C. Dry air or air mixed with water can be injected. Combustion propagates through the oil environment. In an embodiment, the combustion propagates from an injection well to a production well.

Disposal of the steam, in-situ combustion agents (e.g., an oxygen source), and the like can be accomplished using, e.g., a vertical or horizontal well. Further, more than one well can be used. In an embodiment, disposing such items in the oil environment includes injecting via an injection well, which is different than a production well. In another embodiment, disposing an item in the oil environment includes injection in a production well. In a further embodiment, injection (i.e., disposal) can occur in one or more vertical wells, horizontal wells, or a combination thereof. In one embodiment, the oil can be produced in one or more vertical wells, horizontal wells, or a combination thereof by passing through the consolidation that includes the nanocomposite bonded to particles in the oil environment.

Moreover, the configuration (e.g., size, number, or spacing) of injection and production sites (e.g., wells) of can be selected for such control. As a result, the combustion front and heating can be established such that a distance that the oil traverses for production can be minimized or its path of travel optimized to avoid barriers, for example. In certain embodiments, multiple wells can be used such as a multi-spot (e.g., 5-spot) pattern with producing wells (e.g., four producing wells) surrounding an injection well. In a particular embodiment, spacing between wells can be selected based on the surface footprint desired or with respect to physical and chemical properties of the consolidation of the nanocomposite bonded to particles in the oil environment. In some embodiments, the well spacing can be less than 10 acres, specifically less than 5 acres, and more specifically less than 1 acre. In a further embodiment, a vertical well can have multilateral braches. In another embodiment, a horizontal well can have multilateral branches.

In a further embodiment, gravity drainage is used for production of the oil. Here, horizontal wells are positioned such that a first horizontal well is above a second horizontal well. The reactive nanoparticles, resin, and curing agent are injected in the second well and curing occurs to form a consolidation that includes the nanocomposite bonded to particles near the second well. Steam is then injected in the first well, heating the oil environment above the second well and between the two wells. The steam reduces the viscosity of the oil, and the oil flows into the second horizontal well by traversing the consolidation. Alternatively, in-situ combustion can occur by injecting an oxygen source in the first well after forming the consolidation. In another embodiment, heated fluid (e.g., a solvent) can be injected prior to steam injection to remove unreacted resin, curing agent, or reactive nanoparticles from near the consolidation or within the pores of the consolidation.

The nanocomposite and consolidations thereof have beneficial properties due to the resin, reactive nanoparticles, and curing agent used to form the nanocomposite. The nanocomposite is a high temperature composite with advantageous decomposition and flame retardant properties. In an embodiment, the nanocomposite has a thermal decomposition temperature equal to or greater than 150° C., specifically 235° C., and more specifically 300° C. The nanocomposite herein has at least a 5 wt % greater char content than that of the resin cured without the reactive nanoparticles, specifically 10 wt % greater char content, and more specifically 15 wt % greater char content, based on the weight of cure product without the reactive nanoparticles. The nanocomposite has a time to ignition equal to or greater than 30 seconds. The nanocomposite has a self-extinguish time equal to or less than 20 seconds.

The nanocomposite and consolidations herein also have an excellent material strength, including a tensile strength from 50 megapascals (MPa) to 8000 MPa, specifically 300 MPa to 7000 MPa, and more specifically 500 MPa to 7000 MPa. The compressive strength is at least 3 MPa, specifically at least 7 MPa, more specifically at least 10 MPa, and even more specifically 15 MPa. Further, the nanocomposite has a storage modulus equal to or greater than 8 MPa, specifically 12 MPa, and more specifically 20 MPa at 340° C. In addition, the nanocomposite has a glass transition temperature equal to or greater than 150°, specifically 235° C., and more specifically 300° C. In an embodiment, the nanocomposite has a glass transition temperature that is at least 10° C. greater than that of the resin, specifically 50° C., and more specifically 90° C.

A consolidation that includes the particles bonded to the cure product of the resin, reactive nanoparticles, and curing agent has a porosity effective to transmit fluids through pores. The fluid is, for example, crude oil, gas, and the like. Further, the consolidation has a pore size that allows oil to flow through the pores but that blocks or impedes particulates (e.g., unconsolidated sand, rock, oil precipitates, and the like) from flowing and being transmitted through the consolidation. In an embodiment, the pore size of the consolidation is from 50 μm to 800 μm, specifically less than 750 μm, and more specifically less than 600 μm. In an embodiment, a surface of the pores has a chemical makeup that is selective for passage of hydrocarbons (e.g., oil), polar or aqueous fluids (e.g., brine), or a combination thereof. In an embodiment, the surface is hydrophobic, oleophylic, hydrophilic, or a combination thereof. Additionally, a flow rate of fluid through the consolidation is selectable, effective to flow oil, or can be at least 2 liters per minute (L/min), specifically at least 5 L/min, and more specifically at least 10 L/min.

Thus, in an embodiment, a particle stabilizing system includes a resin, reactive nanoparticles, a curing agent to cure the resin and reactive nanoparticles to form a nanocomposite, and particles disposed in a downhole location to which the nanocomposite binds.

Beyond stabilizing particles, the methods and nanocomposite herein can be used as a coating or part, for example, an adhesive, a barrier coating, a bag for an electro submersible pump (ESP), gear, housing, fiber optic cable, logging tool cable, and the like. In addition, items such as a filter, membrane, conduit, partition, and the like can be prepared from the nanocomposite. In a specific embodiment, an optical fiber is disposed in the composition of curing agent, reactive nanoparticles, and rein (which is in a fluid or powder state), and the composition is hardened or cured on the surface of the optical fiber, forming a nanocomposite coated fiber optic cable. In another embodiment, the reactive nanoparticles, resin, and curing agent are introduced into a mold, which is heated to react the composition under compression. The nanocomposite thus formed can be removed subsequently from the mold to produce, for example, an article that can be further machined.

Articles may be formed from the nanocomposite prepared by the above method. As the nanocomposite herein has beneficial mechanical and thermal properties, articles prepared from the nanocomposite will have advantageous mechanical properties, reliability, and environmental stability. Thus, in an embodiment, an article comprises the nanocomposite. The nanocomposite may be used to form all or a portion of an article such as a filter. In some embodiments, an article of the nanocomposite can be useful in a downhole application, such as for example a filter, sand consolidation, packer element, blow out preventer element, torsional spring of a sub surface safety valve, submersible pump motor protector bag, sensor protector, sucker rod, O-ring, T-ring, gasket, sucker rod seal, pump shaft seal, tube seal, valve seal, seal for an electrical component, insulator for an electrical component, seal for a drilling motor, or the like.

The methods and articles herein are further illustrated by the following non-limiting examples.

### Example 1

In a planetary mixer, 12 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 2 g of octaglycidyloctasiloxane. The epoxy resin and octaglycidyloctasiloxane were mixed and 6 g of 4,4′-methylenebis(2-methyl-cyclohexamine). After mixing for 5-30 minutes, 1 g of additional 4,4′-methylenebis(2-methyl-cyclohexamine) was added to the composition. The temperature was maintained at 24 hours for curing. Thereafter, the temperature was increased to 180° C. for 3 hours while mixing. The mixer was cooled to room temperature to obtain a nanocomposite.

### Example 2

In a planetary mixer, 10.7 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 4 g of octaglycidyloctasiloxane. The epoxy resin and octaglycidyloctasiloxane were mixed and 5.3 g of 4,4′-methylenebis(2-methyl-cyclohexamine). After mixing for 5-30 minutes, 2 g of additional 4,4′-methylenebis(2-methyl-cyclohexamine) was added to the composition. The temperature was maintained at 24 hours for curing. Thereafter, the temperature was increased to 180° C. for 3 hours while mixing. The mixer was cooled to room temperature to obtain a nanocomposite.

### Example 3

In a planetary mixer, 9.3 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 6 g of octaglycidyloctasiloxane. The epoxy resin and octaglycidyloctasiloxane were mixed and 4.7 g of 4,4′-methylenebis(2-methyl-cyclohexamine). After mixing for 5-30 minutes, 3 g of additional 4,4′-methylenebis(2-methyl-cyclohexamine) was added to the composition. The temperature was maintained at 24 hours for curing. Thereafter, the temperature was increased to 180° C. for 3 hours while mixing. The mixer was cooled to room temperature to obtain a nanocomposite.

### Comparative Example 1

In a planetary mixer, 12 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 6 g of 4,4′-methylenebis(2-methyl-cyclohexamine). After mixing for 5-30 minutes, 1 g of additional 4,4′-methylenebis(2-methyl-cyclohexamine) was added to the composition. The temperature was maintained at 24 hours for curing. Thereafter, the temperature was increased to 180° C. for 3 hours while mixing. The mixer was cooled to room temperature to obtain a nanocomposite.

### Comparative Example 2

In a planetary mixer, 10.7 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 5.3 g of 4,4′-methylenebis(2-methyl-cyclohexamine). After mixing for 5-30 minutes, 2 g of additional 4,4′-methylenebis(2-methyl-cyclohexamine) was added to the composition. The temperature was maintained at 24 hours for curing. Thereafter, the temperature was increased to 180° C. for 3 hours while mixing. The mixer was cooled to room temperature to obtain a nanocomposite.

### Comparative Example 3

In a planetary mixer, 9.3 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 4.7 g of 4,4′-methylenebis(2-methyl-cyclohexamine). After mixing for 5-30 minutes, 3 g of additional 4,4′-methylenebis(2-methyl-cyclohexamine) was added to the composition. The temperature was maintained at 24 hours for curing. Thereafter, the temperature was increased to 180° C. for 3 hours while mixing. The mixer was cooled to room temperature to obtain a nanocomposite.

### Comparative Example 4

In a planetary mixer, 12 g of an epoxy resin containing triglycidyl-p-aminophenol, bis[4-(2,3-epoxypropoxy)phenyl]propane, N,N,N′,N′-tetraglycidyl-4,4′-diaminodiphenylmethane, and butanedioldiglycidyl ether was combined with 6 g of 4,4′-methylenebis(2-methyl-cyclohexamine). The temperature was maintained at 24 hours for curing. Thereafter, the temperature was increased to 180° C. for 3 hours while mixing. The mixer was cooled to room temperature to obtain a nanocomposite.

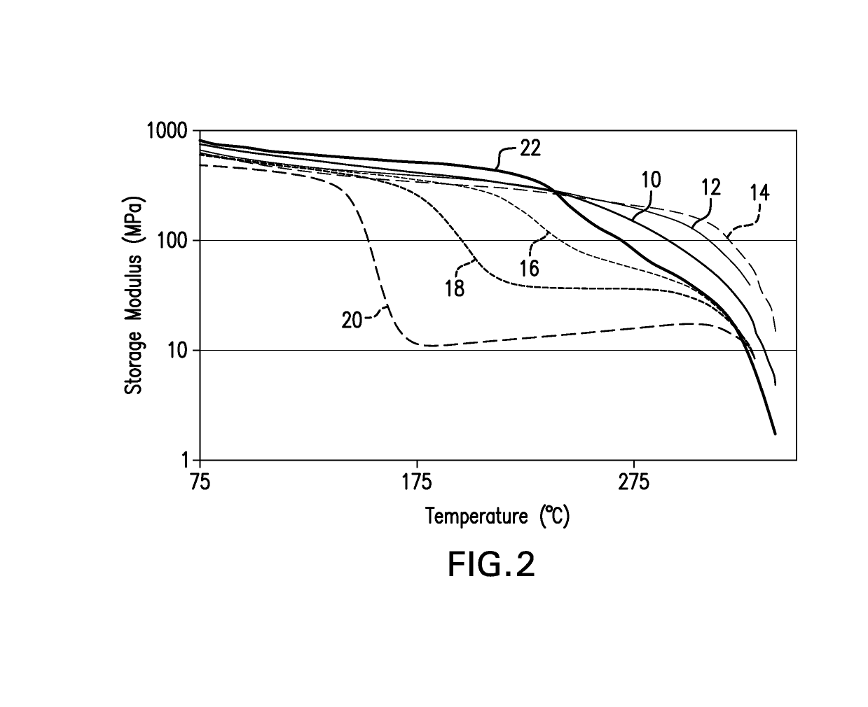

FIG. 2 shows a graph of the storage modulus versus temperature for the nanocomposites of Examples 1-4 and Comparative Examples 1-3, labeled respectively as curves 10-22 in FIG. 2. The nanocomposite of Comparative Example 4 (curve 22) has no silsesquioxane or extra curing agent. An increasing amount of more curing agent (curves 16-20) added to the epoxy resin without any silsesquioxane leads to a decreasing glass transition temperature and storage modulus. After introducing the silsesquioxane with extra curing agent (as compared with Comparative Example 4), the glass transition temperature increases with both increasing amounts of silsesquioxane and curing agent, as indicated by curves 10-14, Examples 1-3 respectively. Thus, the glass transition temperature and storage modulus can be controlled by selection of the relative amounts of the resin, curing agent, and silsesquioxane.

While one or more embodiments have been shown and described, modifications and substitutions may be made thereto without departing from the spirit and scope of the invention. Accordingly, it is to be understood that the present invention has been described by way of illustrations and not limitation. Embodiments herein are can be used independently or can be combined.

All ranges disclosed herein are inclusive of the endpoints, and the endpoints are independently combinable with each other. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” It should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity). The conjunction “or” is used to link objects of a list or alternatives and is not disjunctive, rather the elements can be used separately or can be combined together under appropriate circumstances.

What is claimed is:

1. A process for stabilizing particles, the process comprising:
disposing reactive nanoparticles in an environment which includes the particles;
contacting the reactive nanoparticles with a resin;
introducing a curing agent; and
curing the resin and reactive nanoparticles with the curing agent to form a nanocomposite,
wherein, during curing, the nanocomposite is bonded to the particles to stabilize the particles.

2. The process of claim 1, further comprising introducing a solvent prior to curing; subsequent to curing to remove unreacted resin, reactive nanoparticles, curing agent, or a combination thereof; or a combination comprising at least one of the foregoing.

3. The process of claim 2, wherein the solvent comprises an alkane, alkene, alcohol, ester, ketone, ether, amide, sulfone, sulfoxide, or a combination comprising at least one of the foregoing.

4. The process of claim 1, further comprising varying an amount of the curing agent present with the resin and reactive nanoparticles to control the rate of curing.

5. The process of claim 1, further comprising applying steam to the nanocomposite bonded to the particles, wherein the nanocomposite bonded to the particles is thermally stable at a temperature of the steam.

6. The process of claim 1 further comprising disposing an additive with the resin prior to curing, wherein the additive comprises bauxite, glass bead, alumina, silica, metal, metal oxide, or a combination comprising at least one of the foregoing.

7. The process of claim 1, wherein the reactive nanoparticles comprise silsesquioxane, graphene, graphene fiber, nanographite, oxides thereof, or a combination comprising at least one of the foregoing.

8. The process of claim 1, wherein the resin comprises an epoxy, phenolic, melamine, urea, polyurethane, polysiloxane, polyethylene, polypropylene, polybutadiene, polyisoprene, acrylic, polyacrylamide, polyacrylonitrile, polyacrylic acid, alkenylaromatic polymer, polyamide, polyester, polycarbonate, polysulfone, polyimide, polyarylene sulfide, polysulfide sulfone, polyether, or a combination comprising at least one of the foregoing.

9. The process of claim 1, wherein the curing agent comprises an amine, amide, phenol, thiol, carboxylic acid, anhydride, alcohol, or a combination comprising at least one of the foregoing.

10. The process of claim 1, wherein the particles comprise sand, rock, heavy oil precipitate, gravel pack material, sediment, or a combination of at least one of the foregoing.

11. The process of claim 1, wherein the environment comprises a borehole, production zone, gravel pack, sand screen, frac vein, formation, perforation, or a combination comprising at least one of the foregoing.

12. The process of claim 1, wherein the curing agent is present in an amount from 0.05 wt % to 60 wt %, based on a weight of the resin and reactive nanoparticles.

13. The process of claim 1, wherein the nanocomposite has a compressive strength of at least 3.5 MPa.

14. The process of claim 1, wherein the nanocomposite bonded to the particles has a porosity effective to communicate crude oil.

15. The process of claim 14, wherein a flow rate of the crude oil through the nanocomposite bonded to the particles is at least 2 liters per minute.

16. The process of claim 1, wherein a thermal decomposition temperature of the nanocomposite bonded to particles is at least 600° F. (315° C.).

17. A process for consolidating particles, the process comprising:
coating the particles with a resin;
introducing reactive nanoparticles;
curing the resin and reactive nanoparticles with a curing agent to form a nanocomposite which is bonded to the particles; and
controlling a rate of the curing by an amount of the curing agent which is present with the resin,
wherein the nanocomposite bonded to the particles is thermally stable up to at least 600° F. (315° C.).

18. The process of claim 17, further comprising thermal recovering of crude oil which flows through the nanocomposite bonded to the particles.

19. The process of claim 17, wherein thermal recovering comprises steam assisted gravity drainage, steam cycling, oil upgrading, in-situ combustion, or a combination comprising at least one of the foregoing.

20. A particle stabilizing system comprising:
a resin;
reactive nanoparticles;
a curing agent to cure the resin and reactive nanoparticles to form a nanocomposite; and
particles disposed in a downhole location to which the nanocomposite binds.
